(19) United States
(12) Patent Application Publication
(10) Pub. No.: US 2012/0194478 A1
(43) Pub. Date: Aug. 2, 2012

(54) Electronic Device with None-touch Interface and None-touch Control Method

(76) Inventors: Wei-wei Liu, New Taipei City (TW); Jun Cai, New Taipei City (TW)

(21) Appl. No.: 13/105,903

(22) Filed: May 12, 2011

(30) Foreign Application Priority Data
Feb. 1, 2011 (CN) 201110034353.X

(51) Int. Cl. G06F 3/042

(52) U.S. Cl. 345/175

(57) ABSTRACT

An electronic device with none-touch control interface includes at least an optical sensor each including a light emitter for generating a light signal, and a light receiver for detecting whether the light signal is shaded according to light intensity change of the light signal emitted from the light emitter, and a processor coupled to the optical sensor and used for generating a control command for electronic device control according to at least one of a time length, a sequence, and a time interval that the light signal is shaded when the light receiver detects that the light signal is shaded.

### BACKGROUND OF THE INVENTION

1. Field of the Invention

The present invention relates to an electronic device with none-touch interface and none-touch control method, and more particularly, to an electronic device and related none-touch control method for enhancing usage convenience.

2. Description of the Prior Art

With mankind's increasing reliance on high-tech products, e.g. notebook computers or mobile phones, human-machine interaction have evolved from keyboards, mouse, to the latest touch screens, and are still constantly developing toward a higher degree of simplicity and intuitiveness. When a user wants to use a keyboard or a mouse to operate a computer, but no hand is available, e.g. while holding food, a common inconvenience occurs and sanitation issue rises also. For example, during movie viewing, the user has to clean his/her hands of popcorn grease before performing certain play function operations (e.g. pausing/fast forward/reverse), so as to avoiding staining the keyboard or mouse.

Moreover, with a growing popularity of tablet computer related products, an increasing amount of human-machine interaction is now becoming completely touch-screen based, eliminating need for extraneous buttons as interface. However easy to use as touch screens are, certain inconveniences or hygiene issues still arise from such touch-based operations.

### SUMMARY OF THE INVENTION

Therefore, the present invention primarily provides an electronic device with none-touch interface and a related control method to enhance usage convenience of electronic devices.

An embodiment of the invention discloses an electronic device with a none-touch interface. The electronic device includes at least an optical sensor, including a light emitter for generating a light signal, and a light receiver for detecting whether the light signal is shaded according to light intensity change of the light signal emitted from the light emitter, and a processor coupled to the optical sensor and used for generating a control command for electronic device control according to at least one of a time length, a sequence, and a time interval to generate a control command to control the electronic device.

An embodiment of the invention further discloses a none-touch control method for an electronic device. The method includes generating at least a light signal, detecting if the at least a light signal is shaded according to an intensity change of the at least a light signal, and generating a control command to control the electronic device according to at least one of a time length, a sequence and a time interval that the at least a light signal is shaded, when the at least a light signal is shaded.

An embodiment of the invention further discloses an electronic device with none-touch interface. The electronic device includes a memory for storing a program code for a process, a processor coupled to the memory, for processing the program code to execute the process, wherein the process comprises generating at least a light signal, detecting if the at least a light signal is shaded according to an intensity change of the at least a light signal, and generating a control command to control the electronic device according to at least one of a time length, a sequence and a time interval that the at least a light signal is shaded when the at least a light signal is shaded.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an electronic device according to an embodiment of the invention.

FIG. 2 is a schematic diagram of a process according to an embodiment of the invention.

FIG. 3 is a schematic diagram of a notebook computer according to an embodiment of the invention.

FIG. 4 is a schematic diagram of a first embodiment of the invention.

FIG. 5 is a schematic diagram of a second embodiment of the invention.

FIG. 6 is a schematic diagram of a third embodiment of the invention.

### DETAILED DESCRIPTION

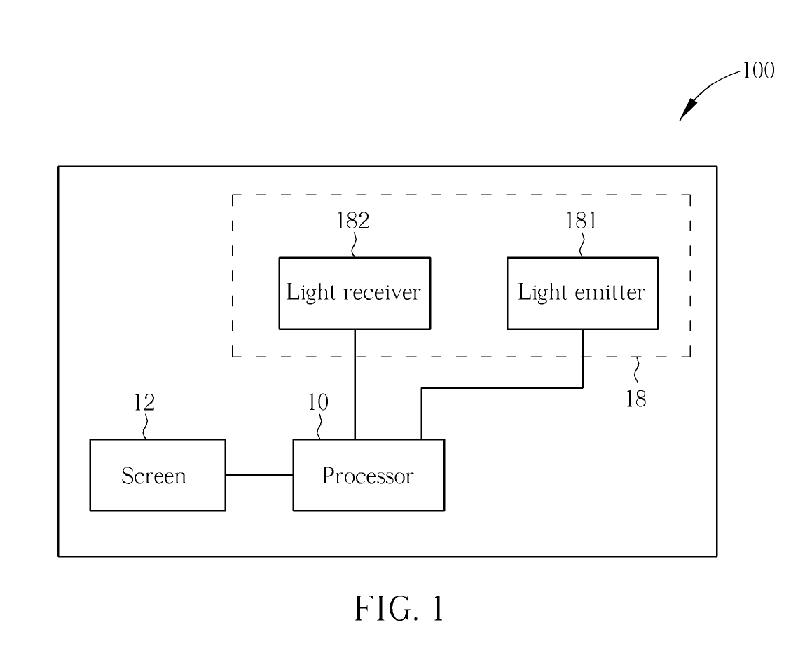

Please refer to FIG. 1, which is a functional block diagram of an electronic device 100 according to an embodiment of the invention. The electronic device 100 includes a processor 10, a screen 12 and at least an optical sensor 18 (for simplicity, only a single optical sensor 18 is represented). As shown in FIG. 1, the processor 10 is connected to the screen 12 and the optical sensor 18. The screen 12 is utilized for displaying data such as documents, video, etc; the optical sensor 18 includes a light emitter 181 and a light receiver 182, wherein the light emitter 181 generates a light signal, and the light receiver 182 for detecting if the light signal is shaded according to an intensity change of the light signal from the light emitter 181. The processor 10 is utilized for generating a control command to control the electronic device 100 according to at least one of a time length, a sequence and a time interval that the light signal is shaded when the light receiver 182 detects that the light signal is shaded.

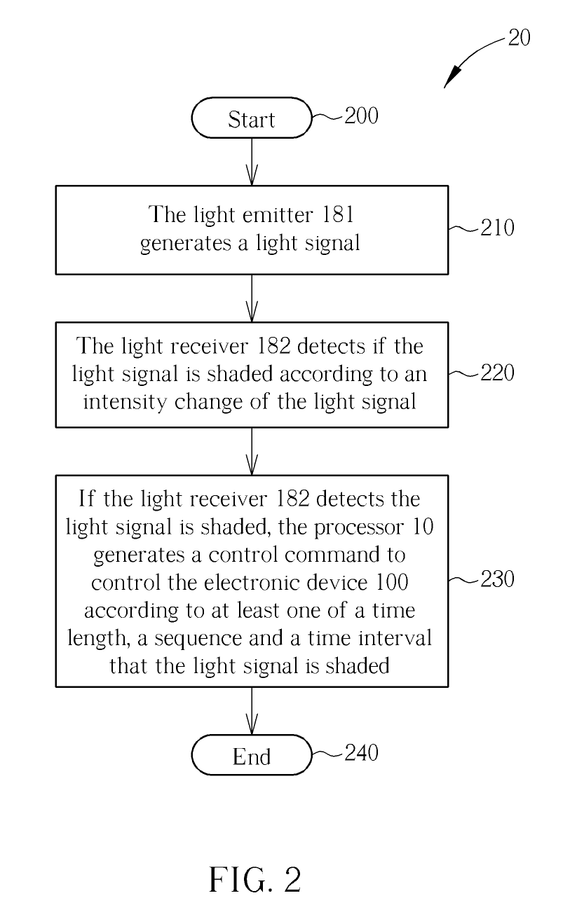

Please refer to FIG. 2, which is a schematic diagram of an operation of the electronic device 100 summarized into a none-touch control process 20. As shown in FIG. 2, the none-touch control process 20 includes the following steps:

Step 200: Start.

Step 210: The light emitter 181 generates a light signal.

Step 220: The light receiver 182 detects if the light signal is shaded according to an intensity change of the light signal.

Step 230: If the light receiver 182 detects the light signal is shaded, the processor 10 generates a control command to control the electronic device 100 according to at least one of a time length, a sequence and a time interval that the light signal is shaded.

Step 240: End.

According to the none-touch control process 20, the light emitter 181 of the optical sensor 18 generates a light signal, and when a user's hand or other objects shade the light signal, the light intensity of the light signal received by the light receiver 182 changes, and the optical sensor 18 generates a sensing signal to the processor 10. Consequently, the processor 10 knows that the light signal of the optical sensor 18 is shaded. After that, the processor 10 determines a time length, sequence and time interval that the light signal is shaded, and then generates a corresponding or preset control command to control the electronic device 100 accordingly. Thus, the none-touch control method for the electronic device 100 is realized. Therefore, usage convenience of the electronic device 100 is enhanced via the none-touch control process 20, thereby reducing hygienic problems caused by the user touching the electronic device 100.

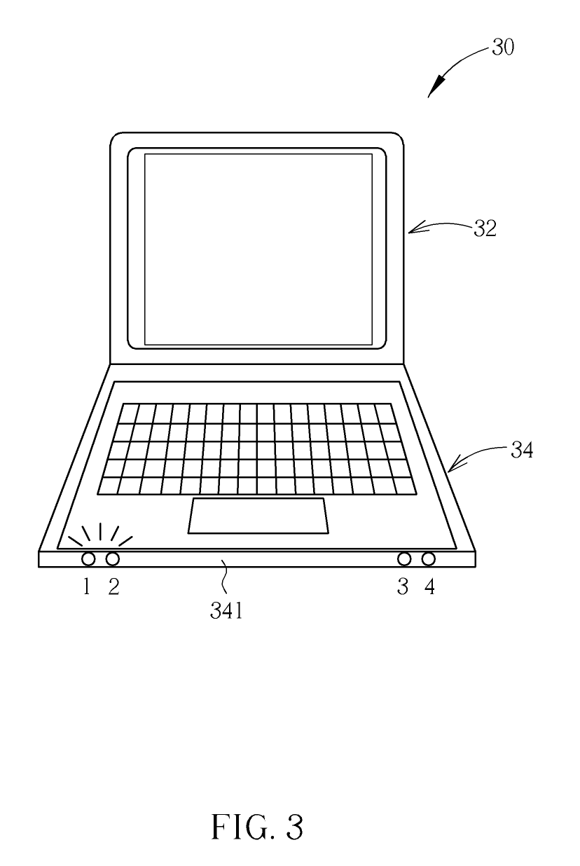

Moreover, the operation of the none-touch control process 20 is illustrated in the following. Please refer to FIG. 3, which is a schematic diagram of a notebook computer 30 according to an embodiment of the invention. As shown in FIG. 3, the notebook computer 30 includes a screen 32, a body 34 and optical sensors 1-4. The optical sensors 1-4 are disposed horizontally on a casing 341 of the body 34. Note that, the optical sensors 1-4 can be disposed on an upper or anterior surface of the casing 341, or on an outer frame of the screen 32. Regardless of an amount, position and method that the optical sensors are disposed, as long as the light intensity change of the light signal can be detected by the processor to generate the sensing signal, namely the processor knows the light signal is shaded, and in turn generate the control signal to control the notebook computer 30, these are possible embodiments of the invention. For example, the optical sensors 1-4 can be vertically disposed instead of horizontally. The amount of the optical sensors 1-4 is not limited to four (e.g. less than or more than four), one with general skills in the art may modify the amount of the optical sensor within scope of the invention. Moreover, the optical sensors 1-4 can be built into the notebook computer 30 or externally connected thereto. For instance, the optical sensors 1-4 can be externally connected to the notebook computer 30 via Universal Serial Bus (USB) interface. Furthermore, the optical sensors 1-4 may be photo interrupters. Photo interrupters have a light emitter (as shown in the light emitter 181 of FIG. 1) and a light receiver (as shown in the light receiver 182 of FIG. 1). The light emitter may be a light emitting diode (LED) for emitting infrared signals, and the light receiver may be a phototransistor for receiving infrared signals.

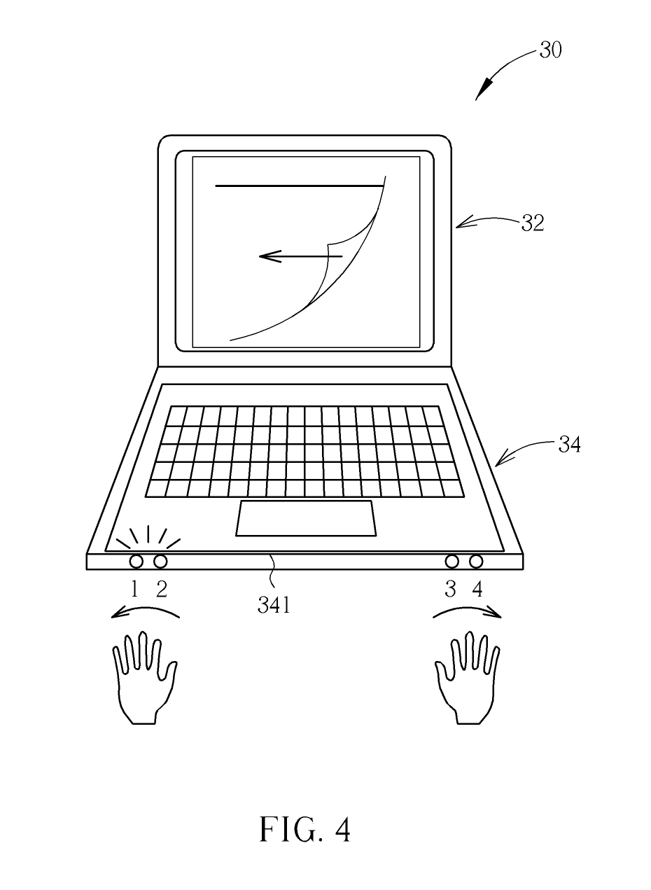

Next, please refer to FIG. 4-6, which are schematic diagrams of various none-touch operations according an embodiment of the invention. As shown in FIG. 4, when the user's hand moves from the optical sensor 2 to the optical sensor 1, light signals of the optical sensor 2 and the optical sensor 1 are sequentially shaded, thus the optical sensor 2 and the optical sensor 1 would sequentially transmit sensing signals to the processor (e.g. the processor 10 shown in FIG. 1). The processor therefore determines a direction of the use's hand movement according to a sequence of the received sensing signals. In this example, the processor first receives the sensing signal of the optical sensor 2, followed by the sensing signal of the optical sensor 1, thus the processor knows the user's hand is moving toward the left, and generates a control command for the screen 32 to flip left. Likewise, when the user's hand moves from the optical sensor 3 to the optical sensor 4, the processor generates a right-flip control command. As can be seen, the invention controls a left-flip and a right-flip function of the notebook computer 30 via a sequence in which the optical sensors 1-4 are shaded by the user's hands. On the other hand, the sequence in which the optical sensors 1-4 are shaded by the user's hand may also be set to control an up-flip or down-flip function of the notebook computer 30, and is not limited herein.

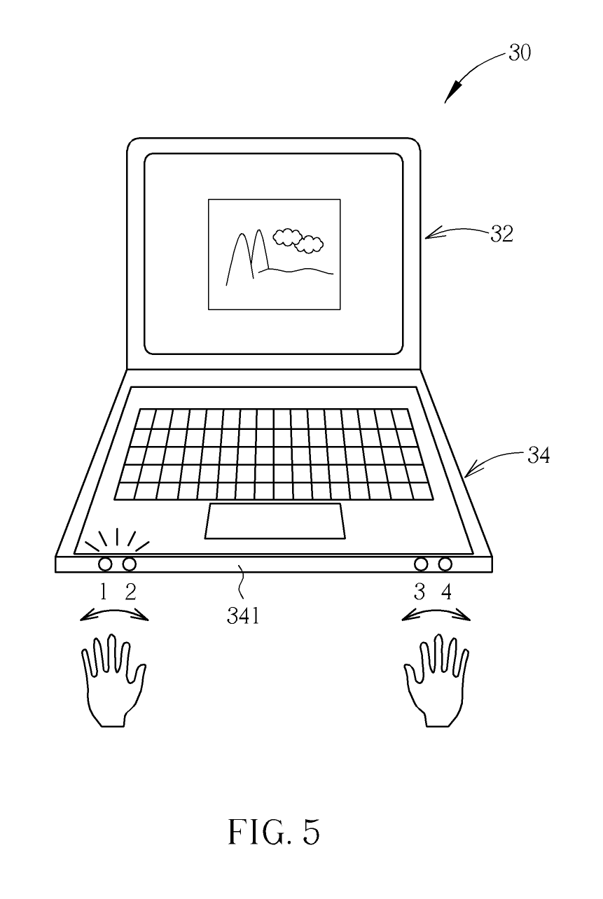

As shown in FIG. 5, when the user's left hand moves from the optical sensor 2 to the optical sensor 1, and the use's right hand simultaneously moves from the optical sensor 3 to the optical sensor 4, the optical sensors 1-4 would sequentially transmit the sensing signals according to the sequence shaded, to the processor. The processor then generates a zoom-in (magnify) command to the screen 32 according to the sequence of the received sensing signals as well as time intervals the optical sensors 1-4 are shaded (e.g. shorter than 2 seconds). Likewise, when the user's left moves from the optical sensor 1 to the optical sensor 2, and the right hand simultaneously moves from the optical sensor 4 to the optical sensor 3, the processor generates a zoom-out (shrink) control command. As can be seen, the invention implements a zoom-in/out function of the notebook computer 30 via the sequence and time intervals which the optical sensors 1-4 are shaded by the user's hands.

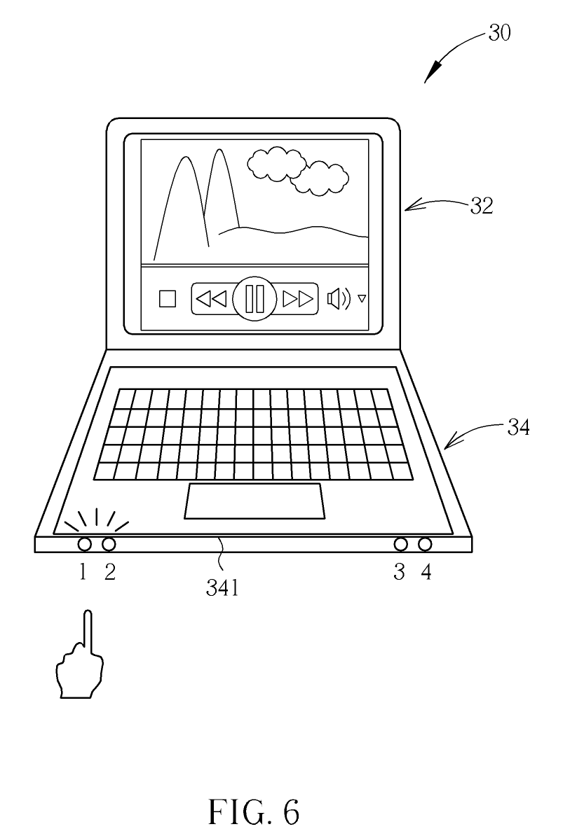

As shown in FIG. 6, when the user's finger shades the optical sensor 1, the optical sensor 1 transmits a sensing signal to the processor. The processor then determines if the user shades the optical sensor 1 for over a predefined time (e.g. 5 seconds). If the user shades the optical sensor 1 for over 5 seconds, the processor generates a play/stop control command to a media playing software of the notebook computer 30. Similarly, the processor generates a reverse control command to the media playing software of the notebook computer 30 when the user's finger shades the optical sensor 2 for over 5 seconds, generates a pause control command to the media playing software when the user's finger stays over the optical sensor 3 for over 5 seconds, and/or generates a fast-forward control command to the media playing software when the user's finger stays over the optical sensor 4 for over 5 seconds. The invention implements a media playing function of the notebook computer 30 via the time length for which the optical sensors 1-4 are shaded by the user's hands.

Note that, above-mentioned embodiments may be applied to devices other than the notebook computer 30, e.g. mobile phones, personal digital assistants (PDA), or touch panels, and are not limited thereto.

In the prior art, electronic devices (e.g. mobile phones, notebook computers and touch panels, etc) are operated via touch controls. Comparatively, according to the none-touch control methods of the invention, the user can remote operate the electronic device “over-the-air” via simple hand gestures. For example, flip commands, zoom-in/out commands and play function control commands of the electronic device can be implemented according to at least one of a time length, a sequence and a time interval that the light sensors are shaded. Detailed description can be referred from above, and is not given herein.

Moreover, one with general skills in the art may choose software or hardware solutions to implement the none-touch control process 20. For example, as shown in FIG. 1, the electronic device 100 further includes a memory, which can be any data storage device (e.g. read only memory, ROM) to store data, including a compiled program code associated with the none-touch control process 20. Thus, the processor 10 reads and processes the none-touch control process 20, to execute and implement the steps of the none-touch control process 20.

In summary, the invention uses a none-touch interface and none-touch control method to achieve remote control of electronic device over the air, so as to enhance the usage convenience of the electronic devices, thereby providing a more hygienic usage environment over the prior art.

Those skilled in the art will readily observe that numerous modifications and alterations of the device and method may be made while retaining the teachings of the invention.

What is claimed is:

1. An electronic device with none-touch interface, comprising:
at least an optical sensor, each optical sensor of the at least an optical sensor comprising:
a light emitter, for generating a light signal; and
a light receiver, for detecting if the light signal is shaded according to an intensity change of the light signal from the light emitter; and
a processor, coupled to the optical sensor, for generating a control command to control the electronic device according to at least one of a time length, a sequence and a time interval that the light signal is shaded when the light receiver detects that the light signal is shaded.

2. The electronic device of claim 1, wherein the optical sensor is a photo interrupter including a light receiver and a light emitter.

3. The electronic device of claim 1, wherein the optical sensor is built into the electronic device or externally connected to the electronic device.

4. The electronic device of claim 3, wherein the optical sensor is externally connected to the electronic device via a Universal Serial Bus (USB) interface.

5. The electronic device of claim 1, wherein the control command includes a flip command and a zoom-in/out command for controlling a display of a screen of the electronic device, or a play command for controlling a play functionality of the electronic device.

6. The electronic device of claim 1, wherein the electronic device is a computer system or a touch screen.

7. A none-touch control method for an electronic device, the method comprising:
generating at least a light signal;
detecting if the at least a light signal is shaded according to an intensity change of the at least a light signal; and
generating a control command to control the electronic device according to at least one of a time length, a sequence and a time interval that the at least alight signal is shaded, when the at least a light signal is shaded.

8. The method of claim 7, wherein the light signal is an infrared signal.

9. The method of claim 7, wherein the control command includes a flip command and a zoom-in/out command for controlling a display of a screen of the electronic device, or a play command for controlling a play functionality of the electronic device.

10. An electronic device with none-touch interface, comprising:
a memory, for storing a program code for a process;
a processor, coupled to the memory, for processing the program code to execute the process;
wherein the process comprises:
generating at least a light signal;
detecting if the at least a light signal is shaded according to an intensity change of the at least a light signal; and
generating a control command to control the electronic device according to at least one of a time length, a sequence and a time interval that the at least a light signal is shaded when the at least a light signal is shaded.

11. The electronic device of claim 10, wherein the light signal is an infrared signal.

12. The electronic device of claim 10, wherein the control command includes a flip command and a zoom-in/out command for controlling a display of a screen of the electronic device, or a play command for controlling a play functionality of the electronic device.
